(19) United States
(12) Patent Application Publication
(10) Pub. No.: US 2008/0072053 A1
(43) Pub. Date: Mar. 20, 2008

(54) WEB-BASED AUTHENTICATION SYSTEM AND METHOD

(76) Inventor: Budi Setiawan Halim, Seattle, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 11/856,383

(22) Filed: Sep. 17, 2007

Related U.S. Application Data
(60) Provisional application No. 60/825,891, filed on Sep. 15, 2006.

(51) Int. Cl. H04L 9/32

(52) U.S. Cl. 713/176

(57) ABSTRACT

A web-based authentication system and method provides centralized management of authentication data for web-based applications. Under typical operation of the system, a user need only remember to authenticate data to the system rather than have to remember various sets of authentication data for numerous web-based applications that the user may authenticate through the system. A user may be authenticated before the user uses the system. Initially, the user has to enter authentication data for various web-based applications that the user wants the system to manage. Upon the user's selection, the system then authenticates to the desired web-based application using the first set of authentication data stored in the system. Since the first set of authentication data is stored on the system, the user does not have to provide the first set of authentication data to authenticate to the web-based application.

### CROSS-REFERENCE TO RELATED APPLICATIONS

This application claims priority to U.S. Provisional Patent Application No. 60/825,891, of which were filed on Sep. 15, 2006.

### BACKGROUND OF THE INVENTION

1. Field of the Invention

The present invention is directed generally to data communication and, more particularly, to authentication systems and methods involving networked devices.

2. Description of the Related Art

There are many web based applications providing services and other resources found on the Internet, which require various authentication information dependent upon the particular web based application involved. A user may need to keep track of different authentication names and passwords for each of several web based applications. For instance, due to lack of integration of different web based applications, a first authentication name used by a first user for a first web based application may be already taken by a second user for a second web based application. Consequently, the first user must use something other than the first authentication name for the second web based application.

Additional complication results from different password formats being used for different web based applications.

Furthermore, conventional security safeguards encourage use of different password content for different web based applications to prevent attempted unauthorized use of a particular password across multiple web based applications. Other conventional security safeguards encourage use of complicated passwords that are hard for hackers to guess and inconvenient for the user to remember.

Consequences may include an unwieldy management challenge for particular users to keep track of various bits of information needed for authentication multiple web based applications.

### BRIEF DESCRIPTION OF THE SEVERAL VIEWS OF THE DRAWING(S)

FIG. 1 is a schematic diagram of a web-based authentication system in a typical operational setting to authenticate a chosen web-based application.

FIG. 2 is a schematic diagram of the web-based authentication system of FIG. 1 showing an implementation for initial configuration of the system with authentication data for the chosen web-based application.

FIG. 3 is a schematic diagram of the web-based authentication system of FIG. 1 showing an alternative implementation for initial configuration of the system.

FIGS. 4A-4D show a flowchart of a depicted implementation of the web-based authentication system.

FIG. 5 is an interaction diagram regarding using a subdomain to avoid XSS.

FIG. 6 is an interaction diagram for passing the authentication directly to the web application.

FIG. 7 is an interaction diagram regarding log-out from all websites.

FIG. 8 is an interaction diagram regarding changing all passwords.

FIG. 9 is an interaction diagram regarding authenticating without the user's browser passing information.

### DETAILED DESCRIPTION OF THE INVENTION

Introduction

A web-based authentication system and method is discussed herein to allow for centralized management of authentication data for web-based applications. Under typical operation of the system, a user need only remember to authenticate data to the system rather than have to remember various sets of authentication data for numerous web-based applications that the user may authenticate through the system.

The authentication system may authenticate a user before the user uses the system. It is common that the user typically authenticates to the system with the authentication data. Initially, the user has to enter authentication data for various web based applications that the user wants the system to manage. Upon the user's selection, the system then authenticates to the desired web-based application using the first set of authentication data stored in the system. Since the first set of authentication data is stored on the system, the user does not have to provide the first set of authentication data to authenticate to the web-based application.

Since the system is web-based, it may be used by a user through a conventional browser application running on a personal computer, workstation, or other device configured to support a web browser application with an internet connection and supporting basic rendering of content such as HTML, WAP, or other such protocols. Typically, the system is operated on one or more separate servers located on a network, such as the Internet. The system server is communicatively linked to a database or other type of data repository either co-located on the system server or located elsewhere. Although, usually, the system is accessed over a network through a browser running on a client machine such as a personal computer, workstation or other device, in some implementations the system may also operate on the computer or other device, which also runs the browser.

Authentication data is stored away from client user access so that; thus the system is able to impose various restrictions for an unauthorized user. For example, the system may stop a brute force attack (such as trying every possible password combination), by limiting the number of trials per hour or per device.

Terminology

For the depicted implementations, basic authentication is based on a model that a client authenticates itself with a user-ID and a password for each web application. Other implementations can be used for other authentication models.

A service provider may be an organization that provides internet-based services, such as banking, to customers over a network, such as the Internet, typically through a web-based application generally running on one or more servers communicatively linked to the network.

Authentication involves a process that allows authentication to a user of a device and/or a device application by identification of the user and typically involves use of a user ID and a user password, but may involve other data.

An authentication page is a web-based page that accepts authentication data from a user.

Authentication data includes data values submitted by a user during an authentication procedure such as for a user ID and a password submission.

A script includes a set of instructions that is usually sent along with data to a user's browser to be parsed and executed. Regarding security concerns, usually a script does not have the potential to cause damage on a client device. A script is generally executed by a browser utilizing a script engine that is usually integral to the browser. Not all browsers have script engines for the possible various script languages, such as JavaScript and Visual Basic.

A plug-in, such as Macromedia Flash and AlternaTIFF, is similar to a script, but are typically installed by a user to the browser. After the plug-in is installed on a browser, an object that is designed for that particular plug-in may be embedded in a web page to be rendered by the corresponding plug-in.

The object might contain instructions, to be executed by the plug-in, such as to read and manipulate web content, or even read and manipulate the browser, in which the object is embedded. A web-based application generally uses plug-ins by embedding associated plug-in objects in a web page associated with a web-based application.

A toolbar, such as toolbars for Google or Microsoft Network, is a device program that is installed on a browser. Unlike a script or a plug-in, most web sites are not presently configured to use toolbar functionality or to inspect and manipulate any web sites.

An authentication submission portion (ASP) is a section of a web page that will receive input data from a user, such as authentication data, and a destination address to which the data is sent such as a web-based application on a server of a service provider. In relation to a web site, the inputs are locations where authentication data is placed. Typically, the ASP is executed by the service provider's server when the inputs are received by the service provider's server. This is termed “Form” in HTML implementation.

Input type is an attribute of the ASP input. Input type determines how the input is displayed and acts. For example, a PASSWORD input type, may replace a user's entry with ‘*’ when the password is typed or a SELECT input type may create a dropdown menu selection when activated.

Cross-site scripting (XSS) is a conventional kind of security exploit where information from one context, where it is not trusted, may be inserted into another context, where it is trusted. An example of this is when someone sends email containing XSS; the script may get information (such as a cookie containing session ID) that may be used to gain authentication to the email program.

Digestion is similar to encryption, except that an encryption is designed so that the encrypted data may be decrypted to the original value. On the other hand, for digestion, the output is not designed so that it may be reverted by decryption to its original value.

An HTTP magic cookie (usually called simply a cookie) is a packet of information sent by a server to a web browser and then sent back by the browser each time the browser subsequently authenticates that server. By using a cookie, the browser is able to retain user identification even after the browser's device is restarted

An Internet gateway is a service that enables devices to connect to the Internet network.

A proxy server is a device network service, which allows clients to make indirect network connections to other network services. For example, usually a cell phone provider acts as a proxy server for a user who browses the Internet via a cell phone.

An original authentication page is a page of a web site that is provided by the service provider to accept the ASP.

A local copy of the original authentication page is stored in the system of the present application. Usually the local copy of the original authentication page is modified to a certain extent to allow for variation in the authentication routine of the user authentication through the system to the service provider's web-based application instead of authenticating to the service provider's web-based application directly. The local copy of the authentication page is not served under the domain name of the service provider's web site.

User modifiable input is an input of the ASP in which value may be modified by a user, such as an ASP input for user ID or password of the user.

Exemplary Implementations

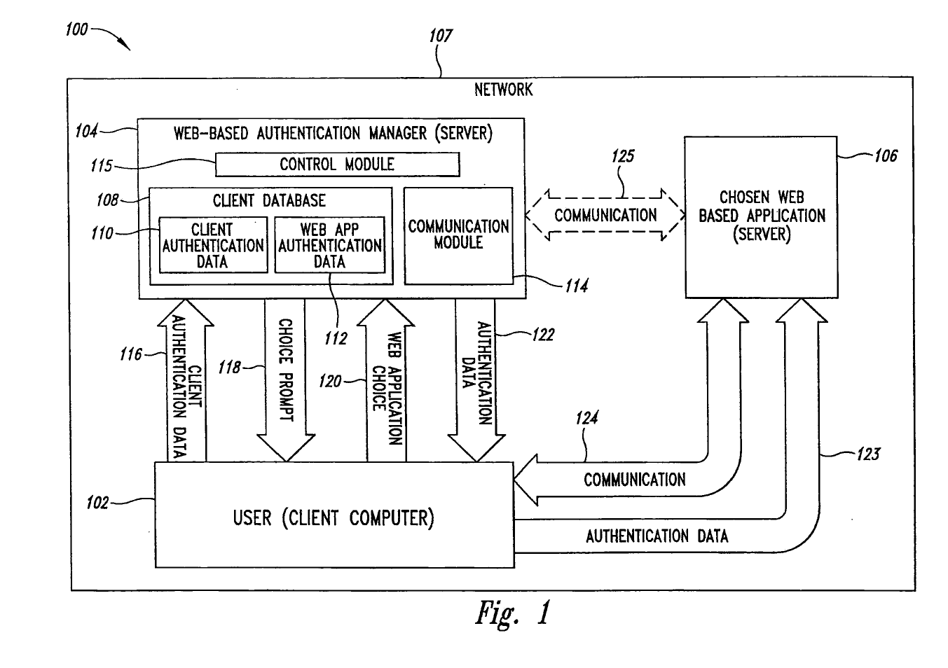

A web-based authentication system 100 is shown in FIG. 1 as having a client device 102, such as a client computer, a web-based authentication manager 104, generally running on a server (such as an authentication server), and a chosen web-based application 106 that typically runs on one or more servers of a service provider (such as an application server). The system 100 further includes a network 107 communicately linking the client device 102, the manager 104, and the web-based application 106. The authentication manager 104 includes a client database 108 having client authentication data 110 and web application authentication data 112. The manager 104 includes a communication module 114 that handles communication links and formatting between the manager and the client device 102 and between the manager and the web-based application 106. The manager 104 further includes a control module 115 that in general oversees, manages, and controls data handling and flow and coordination between the client data 108 and the communication module 114. Although sometimes the control module 115 is explicitly mentioned in all the following discussion as performing a particular activity for the manager 104, in other instances, the manager is generally referred to as performing a certain activity even though the control module may be the particular element of the manager 104 that is carrying out the particular activity described.

With the manager 104 storing sufficient data for a user to be authenticated with the web-based application, the manager may be used by the user to be authenticated with the web-based application during typical operation. This sort of typical operation involves the user directing the client device 102 to send to the manager 104 client authentication data 116, which includes data sufficient for the user to be authenticated with the manager. The control module 115 of the manager 104 compares the client authentication data 116 with associated data stored in the client authentication data 110 portion of the client database 108 and if a match occurs, the user is granted authentication/access to the manager. Included in the client authentication data could be a particular URL on which the client device 102 is located, which could be furnished by a toolbar/plug-in detection of one or more URL entries stored on a browser application running on the client device 102.

Sometimes the application 106 may only require basic authentication data for authentication such that the manager 104 may prompt the client device 102 for a basic authentication of the user. In these situations, the manager 104 may use an ASP that requests the client device 102 for the basic authentication data, or prompts its own basic authentication. In this case when the authentication data is used by the client device 102 to authenticate the user with the manager 104, the manager in turn constructs a special link or a script to allow the client device 102 to authenticate the user with the application 106 using the authentication data used for authentication of the user with the manager.

Once the user is authenticated with the manager 104, the manager sends a choice prompt 118 back to the client device 102 containing sufficient information to assist the user in identifying a selection from a list of web-based applications that have been previously recorded with the manager. The recorded applications may be those applications that the user has at least a minimal degree of authorization to justify managing the authentication of the user with the web-based application. In response to the choice prompt 118, the user sends back through the client device 102 a web-based application choice 120.

Various implementations of the web-based application choice 120 may include information such as specification of a service provider such as by company name or URL to provide a way for the user to specify the service provider.

In some implementations, based upon the application choice 120, the manager 104 then sends web-based application authentication data 122, from the web-based application, authentication data portion 112 of the client database 108 to the client computer 102 to establish communication 124 between the application 106 and the client device 102. The manager 104 can establish optional communication 125 between the manager and the application 106. In other implementations the manager 104 uses the web-based application authentication data 122 to authenticate the client computer 102 with the application 106.

The communication 124 is typically experienced once the client device 102 has authenticated to the application 106 regardless of whether the manager 104 is used to authenticate to the application or whether the client device has authenticated directly to the application without using the manager. The communication 125 is generally a query sent from the manager 104 to the application 106 typically requesting the authentication page containing parameter data from the application and subsequent update data sent from the application to the manager to update the web-based application authentication data portion 112 of the client database 108 and to update the communication module 114. The updates generally keep the manager 104 synchronized with the application 106 so that the manager will continue to be able to authenticate to the application for the user without problems occurring due to changes with the authentication procedures of the application such as with formatting changes or content changes of the authentication data initiated by application management factors.

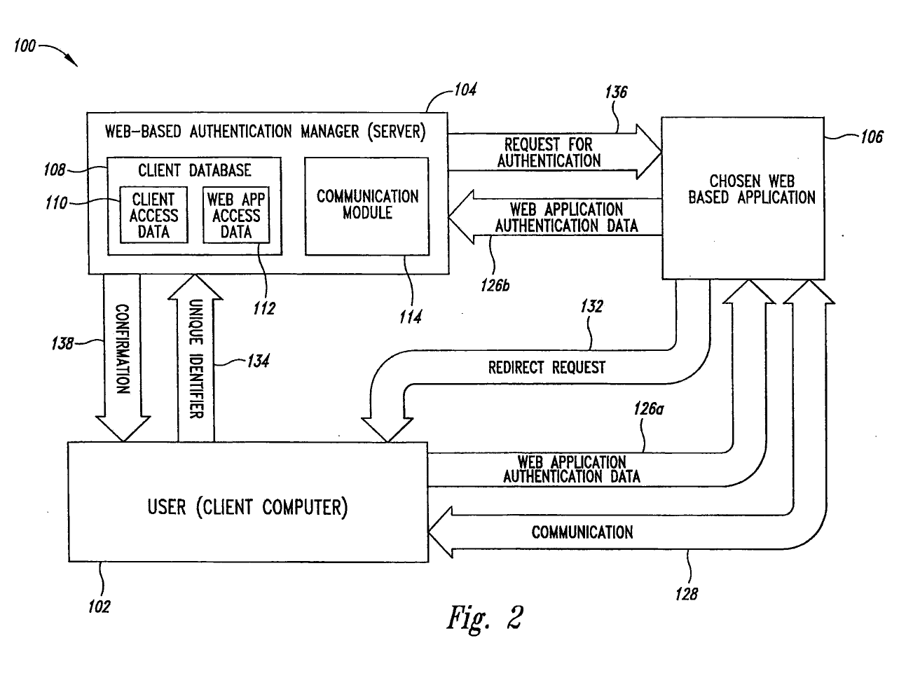

The system 100 is depicted in FIG. 2 as associated with an implementation for initially populating the web-based application authentication data portion 112 of the client database 108 of the manager 104 with authentication data to allow authentication of the user to the application 106. In this depicted implementation the client device 102 first sends web-based application authentication data 126a to the application 106.

A communication 128 is then established between the client device 102 and the application 106 with the user being authenticated to use the application. During or after communication 128, the application 106 sends redirect request 132 to client's browser, with a unique identifier 134, to be sent to manager 104. With this unique identifier, the control module 115 of the manager 104 can request 136 the application to give the authentication 126b to the manager 104 to populate the web-based application authentication data 112 portion of the client database 108 with the web-based application authentication data 126b so that subsequently, the user may authenticate the application by authenticating to the manager using simplified authentication data and authentication procedures compared with the requirements of authenticating directly to the application. After the manager receives authentication from the application 106, the manager sends confirmation 138 to the user. In some implementations the authentication data 126b will be embedded in the redirect request from the application 106 to the manager 104 via client browser.

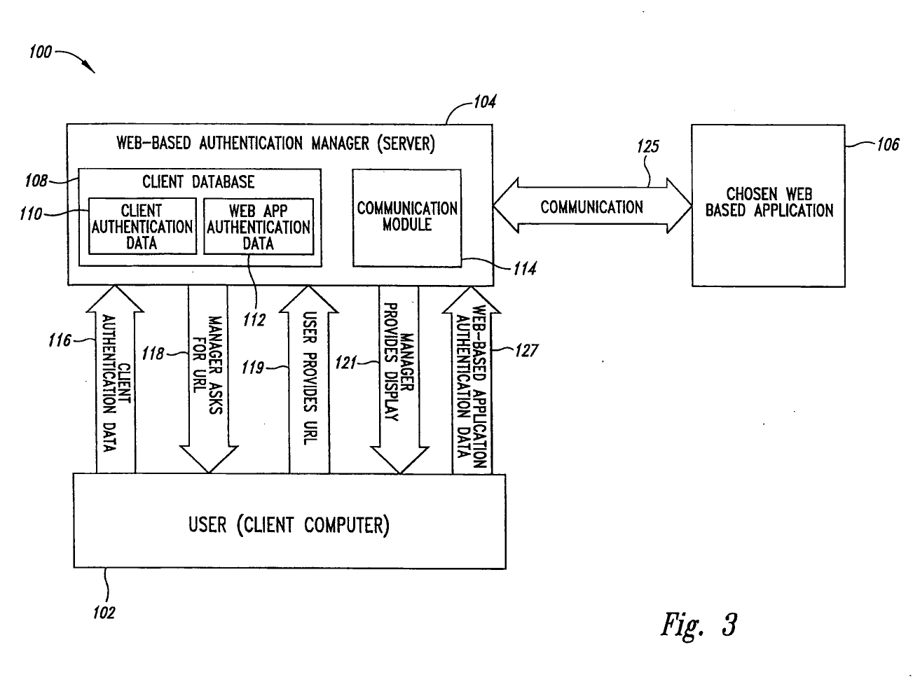

An alternative implementation to initially populate the web-based application authentication data 112 portion for a particular one of the application 106 is shown in FIG. 3 as having the client device 102 first sending client authentication data 116 from the client device to the manager 104. This data 116 may include identification of the user involved. Once the manager 104 authenticates the client 102, the manager then asks the user for a URL 118. The user provides a URL 119, and then the manager 104 subsequently provides the URL to the web-based application 106 via communication 125. The application 106 returns a display of the requested URL to the manager 104. The control module 115 of the manager 104 subsequently provides the modified version of the displayed URL 121 to the client computer 102. The web-based application 106 is now being served by the manager 104. As the user inputs authentication data 127, such as user ID and password, to authenticate the application, the manager sends the authentication data to the web-based application authentication data 112 of the client database 108.

A way to have the user send application authentication data to the manager 104 is to maintain an overall formatting appearance of a user input authentication page used by the client computer 102 to send authentication data to the manager so that the user does not need to learn another authentication presentation format. This is also useful if there are more than one ASP, or if a particular ASP requests more than user ID and password. To maintain the appearance of the user input authentication pages requires a certain amount of duplication and/or modifying of the original authentication pages of the applications 106. This is generally done so that when the user enters authentication data into the client device 102 the authentication data is submitted to the manager 104, instead of to the web application 106. Particular procedures are used to accomplish this such as modifying the destination of the ASP with a URL destination address associated with the manager 104. A script could be introduced to be executed on the browser application running on the client device 102 to change the URL destination address of the ASP from the application 106 to the manager 104.

Furthermore, the script may be added to communicate the original destination address of the ASP to the manager 104 before changing the destination address of the ASP in order to inform the manager of the application 106 associated with the present ASP. To avoid potential problems caused by scripts, the manager 104 may copy, modify, and/or serve the associated script(s) found on the authentication page from the manager's web server. These procedures may be accomplished by removing or disabling or making necessary modifications to part or all scripts involve such as, modifying or removing or disabling other scripts that check for the domain name address of web-based applications that potentially may be the chosen web-based application 106.

To avoid XSS problems caused by malicious scripts, content of a modified authentication page and its related files may be served by different domains than the domain that authenticates the user and/or displays the stored authentication list.

Other procedures may involve modifying or removing or disabling scripts that modify a destination address for the ASP.

Also, a script may be added on to the client device 102 to capture component information of the ASP including destination, input field name, input field value entered, and submitted by the user to the ASP so that the authentication data may still be submitted to the original destination of the ASP. The manager 104 may also be configured to accept and save manual modification by a user of a user input authentication page for custom workarounds such as to modify scripts or HTML code.

Other Considerations

During initial populating of the web-based application authentication data portion 112 and also during general operation, the manager 104 may be configured to detect browser type and operating system on the client device 102, so that the system 100 may format the response correctly. For example, if the user authenticates to the manager, using a cellphone, the manager may send WAP format instead of HTML.

Optionally, in order to furnish authentication data to the manager 104, the browser having a toolbar or plug-in of the client device 102 or a script or other process running on the manager 104 may be configured to parse the original authentication page of the application 106 and request that the user enter the authentication data that is required by the original authentication page.

When entering a URL of the application 106, the user may also include the expected authentication data. For instance, the system 100 may open a connection to the URL of the application 106 and retrieve the resulting web page. Then, an ASP may be located with user modifiable ASP inputs in the resulting web page. Furthermore, extraction of the ASP destination and all inputs could be performed. Also, the ASP could be stored in the manager 104 along with the authentication data for automatic authentication.

Further considerations in capturing input regarding the ASP from the client device 102 may include that the authentication data is verified before being stored on the manager 104. If verification fails, then the manager 104 will prompt the client device 102 for the authentication data again. On behalf of the user, the manager 104 may submit authentication data input name & value previously captured to the application 106 on the server side. Results may then be parsed and a particular text may be searched.

Alternatively, keys that indicate whether or not the authentication was successful may include an authentication ASP that may indicate that the authentication data was incorrect so that the service provider may ask for the user to try to enter the authentication data again. Further things could include a special text (usually error message) or a protocol error code return by the service provider.

Storing authentication data on the manager 104 or elsewhere may involve a number of considerations such as storing all inputs (name, type, value, etc) submitted by the user. Alternatively, only inputs could be stored that may be modified by the user, by evaluating the original ASP and by looking for the ASP input for certain types and states. Only inputs that are modified could be by the user, by comparing the input values submitted by the user with the initial input values found on a web page used to authenticate to the application.

Other factors involve the user being able to modify the ASP including the destination, input types, names and value after the ASP inputs are captured or the inputs are created manually. The user may mark some inputs, so that the manager 104 will ask the user to enter the information on such inputs when the user uses the authentication data later on.

Assisting the user with subsequent use of the authentication data stored by the manager 104 involves further approaches. A web page could be constructed with an ASP that may be visible or invisible to the user that will be used to submit the expected inputs captured to the original destination of the ASP.

Instructions could be formatted according to the browser running on the client device 102 or according to the particular client device used or the particular operating system used. The user may select from a list of available authentication data that the user has already setup.

The user may input values to the ASP in the local copy of the application authentication page residing on the manager 104. Some content that is not necessary for ASP submission may be removed or hidden.

The manager 104 may be configured to connect to the authentication page of the application 106 on an on-going basis or when the user authenticates for the latest information about the ASP since the authentication page may have changed since the user setup the authentication data on the manager 104.

If the old input names may not be found during the process, the old inputs are associated with the new ones based on input types. Alternatively, if such input names may not be found, the old input fields are associated with the new ones based on the order of the modifiable input fields including all or part of the relevant scripts (the original script from the server of the application 106 or a local copy on the manager 104) to the local copy of authentication page.

Other script administration may include modifying or removing or disabling the scripts that check the domain name of the application 106, or the destination address of the ASP, or the scripts that may be used for XSS. Other security measures may include serving associated web pages containing authentication data through domain names different than the manager 104 or the application 106 to avoid XSS and other types of security attacks.

Other implementations of the manager 104 provide capability to authenticate to the application 106 by clicking a link provided by the manager using an identifier for the application for authenticating to the application without an additional authentication data entry requirement. This is usually in certain cases when the user authenticates to the manager 104 and is authorized to authenticate to the application 106.

Some service provider web sites require the original authentication page that is served by the service provider web site to be loaded first. In some implementations, a solution to this could be the original service provider authentication page and/or referral page is first loaded on to the browser running on the client device 102.

For security and other concerns, some implementations use a web page that contains an ASP served to the client device 102 by the manager 104 that is formatted in such a way so that it is relatively difficult for the user of the client device to view the source to discover the actual authentication data.

Other security concerns are addressed by encrypting the authentication data or selected portions of the authentication data such as the user modifiable inputs. The content of the web-based application authentication data 112 may contain one or more scripts to decrypt encrypted data. The script may use a cookie value as a key to decrypt the authentication data. When the cookie value is used, it is modified in order that the cookie value may not be used again to decrypt the authentication data.

Other implementations construct a link that may be used to authenticate to the application 106 with all inputs of the ASP put in a request parameter.

Some implementations send encrypted or digested authentication data only to cooperating applications 106. The encryption used may only be valid for a limited number of authentication events or for a certain duration of time.

In some implementations the manager 104 may act as an Internet gateway, for example as an Internet service provider or proxy server. Accordingly, the system inserts the authentication data to the original authentication page by tempering the original authentication page source code. The authentication data may also be exported to be used by other applications such as other types of password managers and/or browsers.

Some implementations transmit the authentication data from the manager 104 to a toolbar and/or plug-in and/or script, so that the toolbar and/or plug-in and/or script may use the data to populate the ASP on the original authentication page of the application 106. In this case, modification of the authentication page of the application 106 will not be needed and the authentication page will be served by 106, and the ASP may be submitted from the client device 102 directly to the application.

Some implementations display in plain text and/or copy the authentication data to a clip board of the client device 102. There may be additional actions that may be setup after the web-based application authentication data 112 is setup.

Using web based authentication the user is able to log-out from all or a selected group of web apps. An existing action definition may be used if it is previously defined. Communicating instructions to log-out of the application 106 may be at once or sequentially. Some implementations automatically change the password as part of the authentication data to authenticate to the application 106. Also, some authentication data may be shared by several users. As an example, a user may grant another user access or limited access to the manager which in turn may grant access to a bank's website without the second user knowing the access information.

Further Explanation

A toolbar installed on a browser of the client device 102 to send the current URL of the application 106 to the manager 104. The toolbar may detect changes in the browser's address URL, and may ask if the user wants the URL to be processed by the manager 104. Alternatively, the user of the client device 104 may use a certain button on the toolbar to send the URL to be processed by the manager 104.

Basic authentication is another way of verifying the user is a valid user. Basic authentication is different than using an ASP, so is handled separately.

In processing information obtained from the application 106, the manager 104 may need to remove a script from the ASP found on the application 106. For instance, cookie reading scripts may need to be removed since these types of scripts may be used for XSS attack. Alternatively, checks of scripts may be performed and script modifications may be undergone if a particular script attempts to read a cookie variable being put on the client's browser by the system.

The manager 104 may modify authentication pages, so that manager created scripts to replace the ASP destination with the manager's ASP destination to be executed.

The script will read the ASP destination to where the ASP will be submitted, along with all ASP inputs (name & value), including user entered authentication data, and submit that information to the system 100.

In some implementations the manager 104 connects to the application 106, downloads the authentication page of the application, and then parses the authentication page. By parsing the authentication page, the manager 104 will be able to extract the ASP containing destination, input types, input names, etc. By analyzing the ASP information, the manager 104 request the user of the client device 102 to populate the user modifiable input of the ASP. Instead of displaying a page similar to the application 106, such as BankOfSeattle.com, the system will request data particular to the ASP requires (for example social security, account number, and password) to enter the application, such as BankOfSeattle.com, in a simple ASP.

In some cases, the manager 104 does not parse the authentication page first. Instead, the manager 104 relies on the inputs of another authentication manager. Because this is imported from another authentication management application, it is assumed that the other authentication management application has the required input names and values. An example would include the user uploading the authentication data and URL from another authentication management application or browser. Another example would include cases where the user already stored all of the authentication data in a password manager in a browser. Then the user may upload a file that is being used by the browser to store the password to the manager 104, so that the data may be used from and stored at the manager 104.

In some cases a user may manually change the following inputs: destination, type, input name & value, input type, etc.

A browser may ignore requests by the manager 104 not to cache the request whereas typically most browsers will honor such a request. If another person looks at the browser's cache, that person is able to look at the user ID & password easily. If this authentication data is shared, the receiver is able to look at the source code, and easily obtain the authentication data. By encrypting the authentication data, a person who looks at the browser's cache will have to work substantially harder to discover the pertinent values. In these and other cases the manager 104 may send encrypted authentication data to the application 106, with the corresponding script to decrypt it.

In some circumstances scripts may be used to modify cookie values. After a cookie value is used, the value may be modified. Through this procedure another person may not be able to decrypt the value, because the cookie value has been replaced by some other value and is not in the browser cache anymore. Consequently, even if a person may see the cached content, without the correct encryption key (the cookie is the key and value that has been modified), the information may not be decrypted easily.

Instead of passing the information as an ASP submit, the inputs name and value will be passed as request parameters in the URL. However, the user ID and password will appear in clear text, for example: myuserid:mypassword@mybank.com.

In some implementations the user ID and password (or other input as well) are encrypted or digested and then sent to the application 106. The application 106 and the manager 104 should be coordinated with each other according to the encryption method and key.

Optionally, the manager 104 adds a current date in the encrypted password. The application 106 checks if the date added is today, or within a certain acceptable period (for example, yesterday's date will be accepted) in the case that the web app and manager are on different time zones or the clock is not in synch.

For instance, if the user accidentally uses a browser that has spyware, the spyware authenticates everything; including the submitted ASP input name & value. The spyware attacker may then re-submit the input later to gain authentication to the application 106. Even if there is a script on the authentication page to encrypt the access data so that there is a different value for each authentication, the attacker may obtain the original access data before the access data is encrypted.

However, by using the encryption procedures done on server side (in manager 104 web server), there is little opportunity for an attacker to discover the authentication data. The encryption is done on the server side of the manager 104 and the actual access data is never disclosed on the client device 102. Consequently, if the attacker enters the authentication data a day later so that the authentication data is not within the period in which the encrypted password is acceptable, the application 106 will reject the access data.

When acting as an Internet service provider, the manager 104 may modify the content of the original authentication page, instead of creating a copy of the authentication page. This approach has a better chance of success compared to copying and modifying the authentication page to be served from the domain name of the manager 104 as opposed to the original application 106. With this approach, the client device 102 is connected to a network as a subscriber of a certain Internet service provider.

An Internet service provider, such as America-on-line, that has the user of the client device 102 as a subscriber, may provide the manager 104. The user may use the manager 104 provided by the user's Internet service provider to authentication the application 106. However, other users that are not part of the particular Internet service provider, such as not being members of America-on-line, but rather being members of Comcast broadband, for example, may not use the manager 104 of the America-On-Line Internet service provider.

In some implementations, the authentication data entries may be exported, so that the browser or any other authentication manager application may use it. A toolbar may request a list of authentication data of the client device 102 that is authenticated to the system 100. When the toolbar detects a URL change on the address bar or if the user selects authentication data listed on the toolbar, the toolbar may supply authentication data values, after the original authentication page has been loaded by the browser.

Depicted Implementation

A depicted implementation is present herein to provide further illustration of some concepts involved. This depicted implementation involves a number of websites:

| | |
|---|---|
| BankOfSeattle.com | main website example |
| SeattleEmail.com | secondary website example |
| SeattleEntertainment.com | website that requires a special handling |
| SeattleCoffeeHouse.com | website that uses basic authentication |
| BellevueShopping.com | website that doesn't work |
| NotRealBank.com | website that contains XSS attack script |

In the depicted implementation, the manager 104 is installed on one or more remote servers that are accessible via a network, such as the Internet. The user may use any device, such as the client device 102, that is configured for authentication with network such as with a network browser to use the application 106 without requiring additional specialized software to be loaded on to the device. It is possible to install the manager 104 on the user's device, such as the client device 102, so that any browser on the user's device may authentication the application 106. For instance, the manager 104 may be installed on a remote server with AuthenticationWare.com as the domain name.

The control module 115 of the manager 104 could be configured to detect the browser type, device type and Operating Manager (OS) of the user's device, so that the service may be set up and used on different platforms, such as a PDA (or other mobile devices), a smart phone, a device (of different OS: Windows, Mac, Unix, Linux, etc), etc.

For example, after the user sets up authentication data for BankOfSeattle.com on an Microsoft Windows device at the office, the user may use a Macintosh device at home, by selecting a link available in AuthenticationWare.com, to automatically authenticates to BankOfSeattle.com.

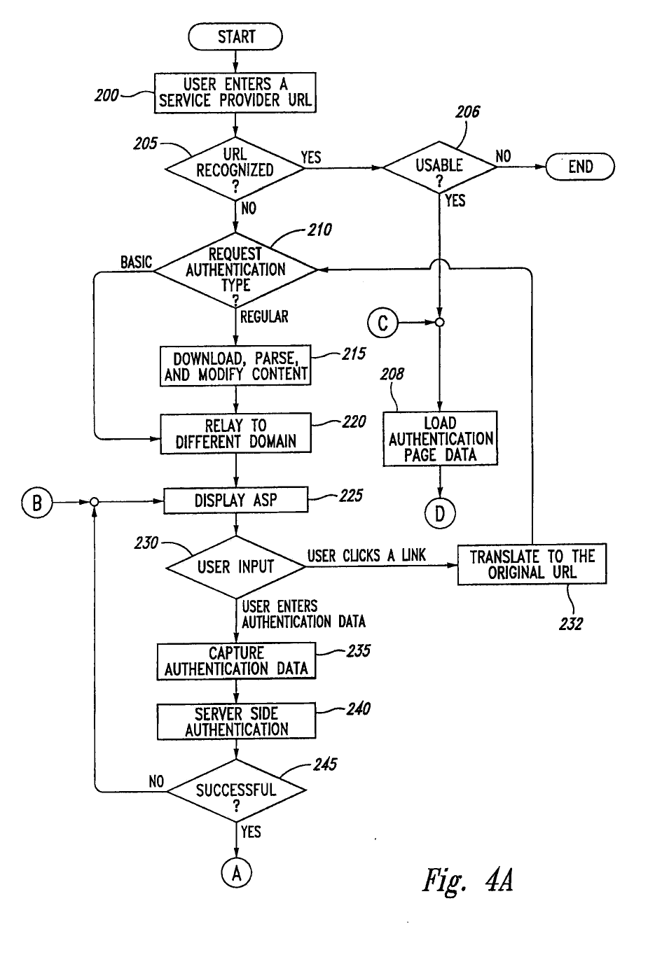

FIG. 4 contains a representative flow chart of a process using the manager 100. A user enters a service provider URL into an entry display provided by the manager 104 to the client device 102 (step 200).

The manager 104 will search the client database 108 that contains a list of recognized URLs of the applications 106 to see if the URL of the desired application is recognized (step 205). The administrator of the manager 104 or the user may build the list of the applications 106 to be stored and to be recognized by the manager 104 by completing steps 200-225. For instance, the manager 104 will search for data that uses BankOfSeattle.com as the URL of the application 106.

If the application 106 is recognized by the manager 104 (YES branch of decision step 205), then the manager goes on to decision step 206 to determine if the application is designated as unusable. If the applications 106 is designated as unusable when authentication data is submitted by the client (as instructed by the manager) then the authentication data is rejected by the web application 106, even if the entered authentication information is correct.

Alternatively, if the URL of the application 106 is marked as unusable (NO of decision step 206), then the manager 104 will notify the user of the problem. Optionally, the manager 104 may offer the user to store the authentication data as literal, for the user to authenticate manually.

For instance, the administrator of the manager 104 may find out that a user may not authenticate BellevueShopping.com through the AuthenticationWare.com. Consequently the URL of BellevueShopping.com is flagged as unusable. When the user wants to store authentication data for the application 106, such as BellevueShopping.com, the manager 104, such as AuthenticationWare.com, will inform the user.

For instance, the manager 104 may offer the user to save only the authentication data for BellevueShopping.com. The authentication data is accessible from anywhere with a network connection, at AuthenticationWare.com. However, the user needs to copy and paste the authentication name and password manually to the BellevueShopping.com ASP in order to access it.

If the application 106 is known to be usable and the manager already parsed the authentication page (YES branch of decision step 206), then the manager 104 may skip parsing the authentication page and load the authentication page data of the application 106 (that's already stored on the manager 104)(step 208). The stored authentication page data may contain a workaround [custom changes to make the application 106 usable by the manager] that the user, the application administrator or manager administrator created. The workaround may also be a special application that runs on the server side, created to accomplish predefined actions, for example retrieving a special input value from the original authentication page.

For instance, the administrator found out, that in order to access SeattleEntertainment.com, the authentication data must include a special ASP input that's different every time. So, the administrator creates a special program that will connect to SeattleEntertainment.com, and retrieve that special ASP input, to be included in the ASP inputs submitted to SeattleEntertainment.com.

If the application 106 is not recognized (NO branch of decision step 205), then the manager 104 loads the URL on server side. By looking at the response returned by web application, the manager 104 may determine if the application 106 asks for basic authentication.

If the application 106 asks for the basic authentication, step 215 and 220 are skipped, since the basic authentication request always asks for authentication name and password. On step 225, the manager 104 will prompt basic authentication or display a simple ASP asking for the user name and password.

For instance, if the user sets up authentication data for SeattleCoffeeHouse.com, which requests a basic authentication, then AuthenticationWare.com will ask the user to provide basic authentication data. If the user sets up authentication data for BankOfSeattle.com (which doesn't request basic authentication), AuthenticationWare.com connects to BankOfSeattle.com server, and retrieves the content returned by the URL specified by the user.

The manager 104 will be able to determine if the application's authentication page type is basic authentication or not (step 214). If it is, then the manager 104 goes to step 225; if it is a regular ASP, then it goes to step 208.

Alternatively, instead of entering the application's URL (step 200), the user may search or choose from a list of the applications 106 that are known to be usable by the manager 104 (step 212).

If the application 106 doesn't ask for basic authentication, the manager 104 downloads, parses and modifies the content of the application's URL (step 215). At minimum, the manager 104 will modify the authentication page, so that the ASP is submitted to the manager, for example by changing the destination of the ASP.

It is preferable to put a unique identification on each ASP destination replacement, so that the manager 104 may identify which ASP is being used. In addition, the manager 104 may change all of the links, so that the link will go to the manager's link instead of the application's (preferably with a unique identifier in the request parameter).

For instance, the authentication page of BankOfSeattle.com contains two ASPs: one to authenticate a corporate account and the other to authenticate an individual account. When the user submits the authentication data to the manager 104, the manager knows which ASP is being used by the user, so that the manager will be able to re-submit the authentication data to the correct destination (corporate account destination or individual account destination).

On step 215, the manager 104 may remove or modify some scripts/plug-in object(s) that may cause the ASP failed to be submitted to the manager 104 and/or cause a problem displaying a page because the content is served from a non-designated domain name (i.e. served from the manager's domain name instead of the service provider's domain). The manager 104 may also change the authentication page, so that the authentication page uses the modified script (that is relevant to the manager), instead of the original script.

To overcome a script that changes the destination of the ASP back to original destination, the manager 104 may add a script (on the modified authentication page) to replace the ASP destination to the manager's location that is executed after all scripts have been executed. [the ASP destination is replaced by the original script will be at the end replaced again by the manager's script]. The script will retrieve and pass the original ASP destination to the manager.

For instance, BankOfSeattle.com includes a script that will modify the ASP destination on authentication page to BankOfSeattle.com/authentication. To avoid this problem, AuthenticationWare.com adds a script (on the modified authentication page) to read the current ASP destination before the actual ASP is submitted to the destination, and store the destination to the manager 104. This will give the manager 104 the last ASP destination that the original authentication page is supposed to use. Then the script replaces the ASP destination with the manager's ASP destination, to be now submitted to the manager 104, instead of the original destination.

To avoid problems displaying authentication pages on different domains, the manager 104 modifies some or all of the application URL/domain to the manager's URL on the script, therefore, instead of expecting the application's URL, the script will expect the manager's URL. Alternatively, all script requests to get the URL of the authentication page are changed to the expected value.

For instance, an authentication page of BankOfSeattle.com contains a script that will test if the page that is currently displayed is loaded from the BankOfSeattle.com domain name.

Because the manager 104 needs to display the authentication page of BankOfSeattle.com through AuthenticationWare.com domain, the script may do something differently (that may cause a problem, such as redirecting to the original authentication page or invalidating a request).

To avoid this problem, the manager 104 changes all reference to BankOfSeattle.com (in all scripts) to AuthenticationWare.com. This way, the script will not detect domain inconsistency and will still do the same action as it is intended originally.

For instance, BankOfSeattle.com includes a script that reverses the password [character by character] (this is an example of really simple encryption) before submitting the authentication data. For example, the user enters samplePassword, then the password submitted to BankOfSeattle.com becomes drowssaPelpmas (the reverse of samplePassword); this is what the manager 104 saved.

If the user decided to submit the authentication data, the authentication data will be sent to the manager 104 (step 235), since the manager modifies the ASP's destination to go to the manager on step 215. The authentication data captured may not be the same as what the user actually enters, since the application scripts may have modified the authentication data.

For instance, BankOfSeattle.com includes a script that will add the current date at the end of the password.

For example, the user enters the password: samplePassword. The script will modify the password to samplePassword07092004 before submitting the password to the designated server, which is BankOfSeattle.com.

BankOfSeattle.com will check for user name, password and a date at the end of the password. Without the modification, when the user sets up the authentication data (on AuthenticationWare.com) for BankOfSeattle.com, the password stored on the manager will be samplePassword07092004 (which is what the original script modifies the password to, at that time).

If the user asks AuthenticationWare.com to resubmit the password a week later, the password will have the same value, samplePassword07092004, not what's expected by BankOfSeattle.com: samplePassword07162004

With the modification, the manager will remove all of the scripts, and the password stored on the manager 104 is what the user entered: samplePassword. When the manager 104 constructs a content to submit the authentication data, some or all scripts are included, including the script to add the date at the end of the password. The script will modify the password to an expected value, which is samplePassword07162004.

Other website's authentication page may have a script to dynamically modify/generate different ASP input name and/or value every time the user uses the authentication data, for example based on time. To avoid this, the manager 104 may remove all (or selected) script/plug-in objects [including the ones that modify input values] (html 5) for that application 106.

Alternatively, the manager 104 may remove only particular parts of the scripts that change the ASP. By removing the scripts, the user authentication data is captured as is by the manager 104 (on step 235), because there is no script that modifies the ASP input. When the user uses authentication data, the manager 104 may put back some/entire scripts/plug-in objects before the authentication data is sent to the destination. These scripts or plug-ins will modify the authentication data to what the web application is expecting.

There are a lot of generic scripts and/or pattern detections and their corresponding modifications that may be added, to avoid problems on ASP capture, content loading, domain detection or other. Also, the manager 104 may download and serve the images and all other dependent files. To do so, the manager needs to modify the content to use the image and the dependent files from the manager 104.

Before the manager 104 displays the content to the user's browser, the manager will redirect the browser to a secondary domain (that belongs to the manager), with an identifier that may be used by the secondary manager to know which user is valid for the first domain, therefore the same user should be valid for the second domain as well (step 220). The secondary domain may be a different domain or a subdomain of the primary domain.

This exercise is done to avoid XSS, so that if any script that tries to retrieve and/or modify the cookie information of the primary domain (that contains the user's authentication data in the manager), it will retrieve and/or modify the cookie information of the secondary domain. The secondary domain may be hosted on a different server, but it's acceptable to host the primary domain and the secondary domain on the same server.

Different sub-domains are used to setup and use different service providers. Alternatively, the manager 104 may delete some or all of the cookies in the secondary domain, before using the domain to serve content from other web applications, so that the previous application's cookie information will not be readable by the current application processed by the manager 104 on the secondary domain name.

For instance, before displaying an authentication page similar to the authentication page of NotRealBank.com, AuthenticationWare.com redirects the request to handleXSS.AuthenticationWare.com. The authentication page will then be displayed in handleXSS.AuthenticationWare.com. If the modified authentication page were served from AuthenticationWare.com and if a script in NotRealBank.com's authentication page contains a script to read the domain cookie (that may identify the user's session), the attacker may use the information to pretend that the attacker is already authenticated to AuthenticationWare.com as the user. To avoid this problem, AuthenticationWare.com will redirect the request to handleXSS.AuthenticationWare.com. To enable the second domain to recognized the user from the first domain, the applications on both domains need to establish a communication, such as adding a unique identifier in the redirect request to the second domain. This unique identifier is used by handleXSS.AuthenticationWare.com manager to validate the user (who is authenticated to AuthenticationWare.com) and to locate his/her authentication data. The script on NotRealBank.com may contain XSS script, and the XSS script is being served to the browser through handleXSS.AuthenticationWare.com. Even though the attacker might be able to use the information to pretend that the attacker is already authenticated to handleXSS.AuthenticationWare.com as the user, the data on handleXSS.AuthenticationWare.com doesn't contain any other data that the attacker doesn't already know, such as the authentication data of the user in NotRealBank.com.

The manager will be able to determine if the web application is set up as basic authentication or regular ASP.

The manager 104 will prompt for basic authentication or authentication page asking for the authentication name and password if the web application requests basic authentication.

For instance, if the user sets up authentication data for SeattleCoffeeHouse.com, the manager will display a generic ASP asking for authentication name and password (through handleXSS.AuthenticationWare.com) or prompt its own basic authentication.

If it is basic authentication, then the manager 104 executes step 225; if it is a regular authentication ASP, then it executes step 208.

On the modified authentication page, the user may click on a link, click on a form, or submit authentication data (authentication ASP), or submit navigation information (navigation ASP) (step 230). The manager 104 needs to distinguish these, and may respond by either redisplaying the modified version of the other URL that the user chose (step 232) or verifying if authentication is successful (step 245).

The manager 104 may analyze the content and replace the link, authentication ASP or navigation ASP with different handlers (ASP destination) according to its type. An authentication ASP usually contains a user changeable input, especially text input and password input type. A navigation ASP usually doesn't contain user changeable input ASP, such as hidden input type.

As an alternative, the manager 104 may analyze the ASP type when the user submitted the ASP; the manager 104 compares if the input values submitted by the user and input values of the original ASP are different. If the input values are different, then the user most likely supplies an input (and most likely, the user submits an authentication ASP).

When the user clicks on a navigational link, then the unique identifier in the request parameter will be used to determine the original URL (step 232). Then, the manager 104 retrieves the content of original URL (step 210), to modify the content of the original URL and display it to user. If the user submits ASP, then the manager re-submits the ASP inputs to the original ASP destination, and executes step 210.

For instance, if the URL that the user enters isn't the authentication page (for example, it's an introduction page for BankOfSeattle.com), the user may click on other links. The manager 104 already modified that link, so that it becomes a link to the manager (not to BankOfSeattle.com link). Then the manager 104 translates the link and modifies the content and displays the modified page to the user. The user may do this until he/she may locate the authentication page.

It is acceptable that the manager tries to simulate the authentication process to the web application at server side, so that the manager 104 may prompt the user if there is a problem using the authentication data to authenticate (step 240).

For instance, after the user sets up the authentication data for BankOfSeattle.com, the manager 104 will simulate ASP submission to BankOfSeattle.com, to authenticate on behalf of the user, on server side, so that the manager may determine from the response from BankOfSeattle.com if the user authentication is successful.

The manager 104 may try to guess if the authentication process is successful or not, by looking for certain keywords/texts (or response code), in the content of ASP submission response (step 245); most likely the ASP similar to the authentication ASP used to submit the authentication data. The user or manager administrator may define a certain keyword to look for (for example “Invalid Authentication”), for a certain application. If the manager 104 detects a failure, then the manager redisplays the request for authentication data again (step 225). The user may choose to ignore the manager auto-detect, and ask the manager 104 to store the authentication data anyway, even if the manager detects a failure.

For instance, the manager administrator may have an account on BankOfSeattle.com, and notice that every time a user enters incorrect user name or password, the manager 104 will display a page, that contains “Invalid Authentication” in red text. In addition, the manager administrator sets up this application 106, and adds a condition to search for “Invalid Authentication”. The absence of the text in the response indicates a success.

If the authentication verification is successful (or the user asks the manager 104 to save the authentication data), the manager saves the authentication data. It is acceptable that the modified version of authentication page data is also saved (if the authentication page data is not already in the database), so that the manager 104 doesn't have to process the service provider's authentication page again, and the user doesn't have to redo any workaround again for subsequence set up (if a workaround is created); this will make up a list of recognized applications, used by step 205. It is acceptable that the manager 104 stores the modified authentication page content and all of its dependent images, CSS, script, etc. as files.

Alternatively, after step 250, the manager 104 may perform an automatic authentication to the application 104 (step 270), on the user's browser, so that the user may determine if the authentication process is really successful or not. For example, the user fills out the authentication data of HTML 1. The manager receives ‘foo’, ‘usrName’, ‘passwd’, ‘auto-authentication’ and their respective values as the inputs from user.

Alternatively, the manger may store only inputs that are modified by the user. By comparing the submitted input values and the ASP values from the authentication page, the manager 104 identifies that the ‘foo’ and ‘submit’ button are not user modifiable ASP inputs and ‘usrName’, ‘password’ and ‘auto-authentication’ are the user modifiable inputs. The manager 104 may also look at the type of input to determine which ones are user modifiable inputs. The manager 104 may also identify the ASP method, encoding and the original ASP target, and store such information in the database 108.

It is acceptable that the inputs are stored on different tables, so that the manager 104 has a more structured means to store information of each of the input properties, such as the input type. After the user enters authentication data, the user may mark the input, so that the manager 104 will ask the user for the value of this input. This feature may be used where the user needs different values for every use. For example, the user may need to enter code generated by a token device every time.

After setting up one or more authentication data, the user may use one of the authentication data to authenticate to the web application, by choosing from the list of authentication data that the user has.

For instance, after setting up BankOfSeattle.com and SeattleEmail.com, the user is able to see those entries in AuthenticationWare.com. By clicking on a special link on AuthenticationWare.com, the user is automatically authenticated to BankOfSeattle.com or SeattleEmail.com or both. The manager 104 may provide an option for the user to look at the authentication data in plain text, so that the user may use the authentication data manually.

The manager 104 loads the necessary information related to this authentication data (step 260).

This link may be posted on the application 106 or the manager 104. Such link may contain an identifier on a request parameter, so that the manager 104 may use an identifier to identify the application 106, and search the corresponding authentication data for the user currently authenticated to the manager 104. The manager 104 may assign the identifier for the application 106; alternatively, the domain name itself may be used as an identifier. Instead of using an identifier, the manager 104 may use the referral header (that contains domain name) to determine which authentication data should be used, if the manager's link is posted on a service provider's website. The application's website may redirect the browser to follow the link, to automatically authenticate the user, if the user has the authentication data for this application.

For example, the link is http://authenticationware.com/authenticationBySPid.do?spid=14. The manager 104, given application identifier of “14”, the manager looks (step 263) at the user's available authentication data—the user currently authenticates to the manager. If the user doesn't have such entry for the application 106, the manager 104 may ask the user to enter his/her authentication (step 225).

The manager searches the authentication data for the web application (step 262). For the user that has multiple authentication data for an application, it's acceptable that the manager 104 prompts the user to select which authentication data to be used.

If the user's authentication data for that application is not found, it is acceptable that the manager 104 prompts the user to enter the authentication data, thus the user will set up the application 104 for the first time (step 225). If the authentication data is found, then the manager 104 will perform step 260. In this example, the manager 104 found that user ‘joe’ has such authentication data.

For instance, the BankOfSeattle.com website may have a link to AuthenticationWare.com, with a unique identification for it (that is b 14). The user may click on the link, and be automatically authenticated to BankOfSeattle.com through AuthenticationWare.com, if the user has already been authenticated to AuthenticationWare.com, and has authentication data for BankOfSeattle.com. If the user sets up more than one authentication data for BankOfSeattle.com, the user will be asked to choose which one the user wants to use.

The manager 104 performs the same step as step 220, to avoid XSS attack, if the original scripts are embedded in the auto-authentication content (step 165).

Optionally, before submitting the authentication, the manager 104 causes the user's browser to load the original application authentication page and/or load the referral page (step 170).

For instance, the user will briefly see that the browser loads the authentication page of BankOfSeattle.com, then the page will be replaced by some text explaining that the authentication is in progress (this is where the authentication script is loaded), and replaced again by the user authenticating to the BankOfSeattle.com page.

On a cooperating web application, the authentication page (that's located on web application's 106 web server) may contain javascript that originated from the manager's 104 web server. Because the javascript originated from the manager's 104 web server, it may determine if the user has been authenticated to the manager 104, and if the user has authentication data for this particular web application. The javascript may look at the domain name, where the javascript is embedded, and pass this information to the manager 104. And the manager may use this information, to determine if the user has the authentication data. Because the JavaScript is embedded on the web application's authentication page, the JavaScript may add the authentication data to the authentication page. This feature may enable the user to automatically fill in the authentication data on the web application that supports this feature, from any browser and/or any computer.

For example, BankOfSeattle.com implements this feature, by adding JavaScript that belongs to AuthenticationWare.com. By clicking a certain button, the user may fill in the authentication of BankOfSeattle.com data.

The manager 104 determines if the user sets up the authentication data using basic authentication or using a regular authentication ASP (step 275). If the user sets up the authentication data using basic authentication, then the manager 104 constructs a link or script that enables the user to automatically authenticate the application 106 (step 277).

For instance, using example of step 210, when the user uses SeattleCoffeeHouse.com authentication data, the AuthenticationWare.com will redirect the user to SeattleCoffeeHouse.com through a link similar to this: sampleAuthentication:samplePassword@SeattleCoffeeHouse.com (this is an example of implementation in HTML).

Some browsers do not support this format, so the manager 104 may display the authentication name and password for SeattleCoffeeHouse.com, and the user has to copy and paste the authentication name and password in order to authenticate manually.

If the user inputs the authentication data using regular ASP, then the manager 104 sends a web content to the browser that contains the ASP that has the original ASP destination along with the user's authentication data and the hidden ASP inputs (step 280), and auto submits the authentication data.

It is acceptable to remove all the content of the authentication page except the ASP and its dependent script, so that the page is cleaner and faster to load. It is acceptable to hide all of the inputs, so that the user may not modify the input anymore. It is also acceptable to encrypt the ASP inputs, so that the source code doesn't contain input values in human readable format/text. It is acceptable to add a script to automatically submit the ASP (to automate the authentication procedure).

For example, to enable auto-authentication of an alternative first authentication web page, the manager 104 may generate a first authentication page and may send the content to the user's browser. The alternative first authentication page contains only a sufficient portion that's needed to authenticate, with its original ASP destination to be submitted directly to the application 106. The alternative first authentication page contains a server-encrypted password (with a script containing an algorithm(s) to dynamically decrypt the authentication data on the client side), and contains a script to auto-submit the ASP to the application 106.

To enable auto-authentication of a second web application, the manager 104 generates an alternative second authentication web page, because the input value needs to be generated dynamically by the script. For example, the manager 104 uses information about what fields are required along with their respective user inputs to construct the alternative first and second authentication pages.

If the user was able to authenticate a certain one of the applications 106 previously, but currently he/she is unable to do, the user may ask the manager 104 to re-process the authentication page, and apply the authentication to the current authentication page using the user's authentication data. This case may be caused by introduction to a new ASP structure or composition, especially in terms of field identifiers and/or their default values.

The manager 104 compares the input fields involved in the current authentication page with the one that's already stored in the manager. When the manager 104 finds inconsistency, it will use the new ASP composition along with respective input fields. The manager 104 locates the ASP with the same modifiable input fields (such as text input and password input) as the old ones.

Based on the input field types, the manager 104 may try to relate the old input fields to the new ones. For example, the name of the old input of text type is ‘usrName’. The name of the new input of text type of the new ASP is ‘authenticationName’. The old input field of password type is ‘passwd’. The new input field of password type of the new ASP is ‘secretKey’.

All ASP inputs in the old ASP will be replaced by the ones on the new ASP. The ASP will be submitted to the new destination. For instance, the user sets up authentication data on BankOfSeattle.com and is able to use it for several months. After the owner of BankOfSeattle.com replaces the authentication page (the input ASP fields are changed as well), AuthenticationWare.com is no longer able to automatically authenticate the user. The user asks that AuthenticationWare.com applies the pre-existing authentication data to the new authentication page.

Additional Illustrations

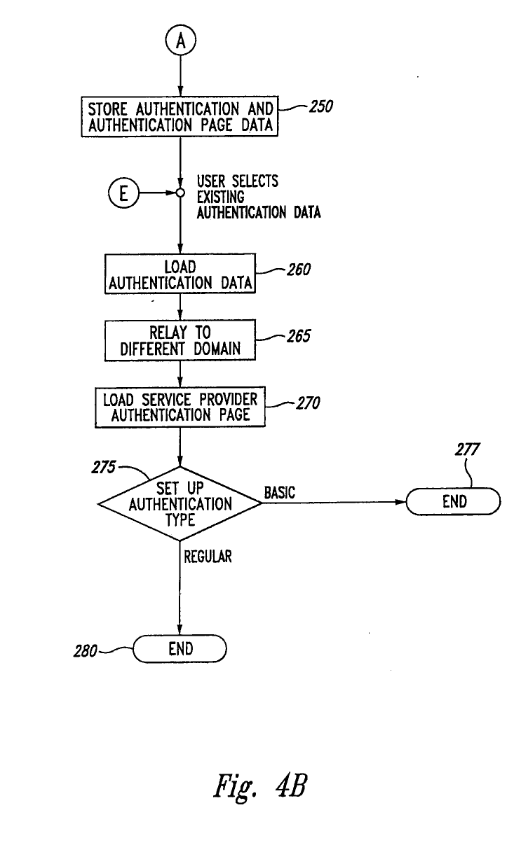

As shown in FIG. 5, the user wants to view a content (that includes a trusted or distrusted script) on the manager 104 (step 400). For example, the user wants the manager 104 to display the modified web content of one of the applications 106. The manager 104 requests the original content from the application 106 (steps 405 and 410), or the manager may have the content already for this application.

The primary domain redirects the browser to the secondary domain (subdomain), with identifiable token in request (step 415). The primary domain may include an identifier in request parameter; it may include an identifier as one of the ASP inputs, or the application 104 uses an identifier of the referrer (primary domain) URL parameter. Or the manager 104 may identify the user's session by the I P address used. This is done, so that a valid user on the main domain is also a valid user on the subdomain.

The secondary domain opens a network connection to the primary domain (or searches its memory/data, if the both domains are served by the same server), using the identifier (step 420). Using the identifier, the primary domain is able to know which user, the secondary domain refers to (step 425). The manager of secondary domain serves the request result to user (step 430). Even if the XSS script is able to get the session ID that's passed (from the primary domain) on the secondary domain (where the script is served), the information gained is limited to what the primary domain puts on the secondary domain.

The manager 104 may be made more secure if the application 106 agrees to use upon predefined different method of authentication data transfer. To avoid potential problem caused by spyware installed on user's client device 102, the more secure way is not to pass the authentication using user's browser or network connection. For spyware may monitor any input entered in ASP, or monitor network connection for activities.

For instance, the AuthenticationWare.com doesn't send the authentication data (encrypted or not) as a content to user's browser. Instead, the AuthenticationWare.com will send BankOfSeattle.com a unique identifier associated with the user who wants to authenticate to BankOfSeattle.com through Authenticationware.com.

Using the identifier, BankOfSeattle.com opens a direct connection to AuthenticationWare.com, and requests the authentication data. AuthenticationWare.com knows which user and authentication data represented by the identifier, and sends it to BankOfSeattle.com. BankOfSeattle.com will treat the authentication data obtained from AuthenticationWare.com as if the user submits the authentication data from the user's browser.

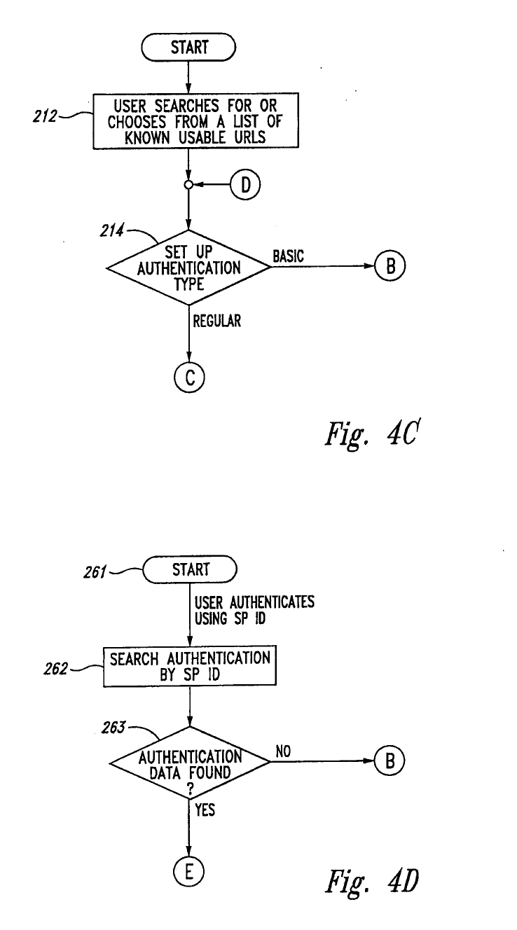

Similarly, the following discusses steps involved to send the password directly to the application 106 as shown in FIG. 6. The user requests that the manager 104 sends an authentication to the application 106 (step 500). The manager 104 sends an instruction to the user's browser, to redirect the request to the application 106 with a unique identification (step 505). The instruction may be a ASP that is submitted automatically, or header redirect or any other types of instruction. The unique identifier may be included in request parameter; as one of the ASP input, or in the referrer (the manager 104) parameter.

The user's browser executes the instruction, causing the user's browser to view the application 106 (step 510). The application 106 opens a direct connection (not using user connection) to the manager 104 (step 515). The application 106 includes the unique identifier that's generated by the manager in step 510, when connecting the manager 104.

Based on the identifier, the manager 104 is able to identify the user, and the authentication data the user has selected (step 520). The manager 104 responds by sending authentication data (encrypted or not) to the application 106. The application 106 verifies and allows the user authentication to the application (step 525). Alternatively, the application 104 may be the one that generates the random identification, and sends it to the manager, and the manager initiates opening direct connection to service provider.

The manager 104 may record action chains (while serving as a proxy server), by recording every action that the user takes, when the user clicks/submits modified page (for instance, see steps 210-232 above). This action chain may be used to log-out all of the applications 106 that the user has authenticated to, and may be used to change the password at a pre-defined time, or any other task. The manager 104 may perform a custom chain of actions at a pre-defined time, or the user may trigger the action chain with a single click.

Steps for logging-out of all of the web applications:

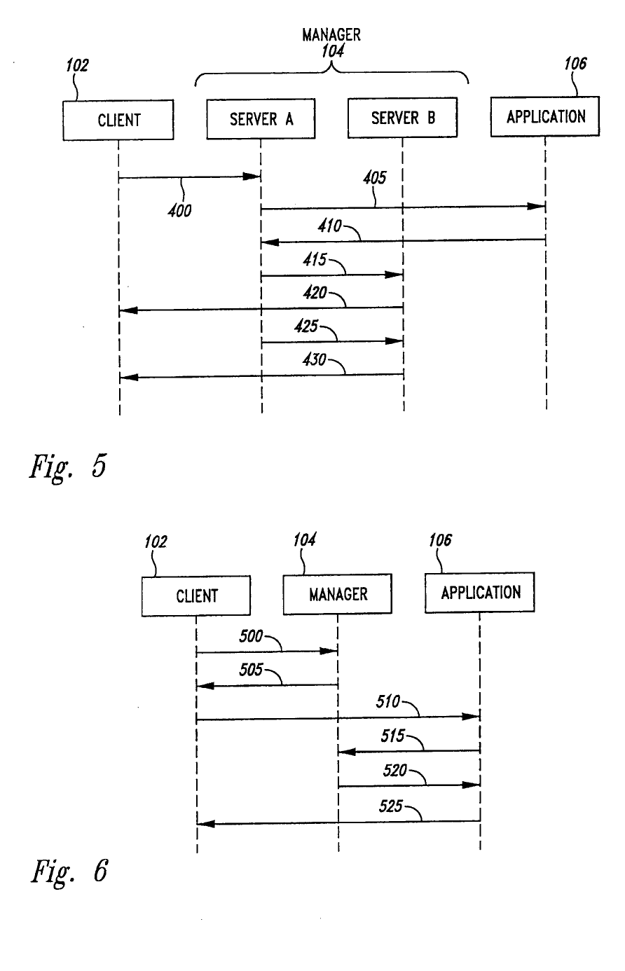

A procedure for logging-out of the application 106 is shown in FIG. 7 in which every time the manager 104 executes step 275, the manager authenticates the application that the user authenticates to and remembers this event. The manager 104 may have a sequence of actions to log-out (either defined by the user or the manager administrator). This sequence of actions for log-out usually only involves submitting a certain ASP, or clicking on a link.

For instance, the user uses AuthenticationWare.com to authentication to SeattleEmail.com and BankOfSeattle.com. The manager 104 records that the user had authenticated these websites (SeattleEmail.com and BankOfSeattle.com). Using a button or a link, the user may ask the AuthenticationWare.com to send a script to the user's browser that would be executed by the browser to perform log-out procedures, so that the user will log-out of SeattleEmail.com and BankOfSeattle.com. So, instead of clicking the log-out button from each website, the user may use one button to log-out of all websites.

As shown in FIG. 7, the user requests that the manager 104 logs-out of all the websites that the user is currently authenticated to (step 600). The manager 104 sends web content that contains a browser instruction that causes the user to log-out from one of the applications 106. If the manager doesn't send all of the instructions to log-out of all of the websites at once, the browser instructions sent may also contain an instruction to load the next instruction (to load the rest of the service provider's log-out call).

The user browser executes the instructions to log-out (step 610). It is acceptable that the application 106 sends back a confirmation of log-out to the manager 104 by having the user's browser redirected to a certain page on the manager or by having a direct communication from the application to the manager. The next instruction may be executed at a certain interval after the previous action has been executed, or all instructions are executed at once on different browser windows (step 610, step 620, and step 630 are executed sequentially). Acceptably, the manager 104 also includes instructions for the browsers so that they would be closed automatically after a certain time after executing the log-out procedure. Log-out steps 625 and 635 are then performed subsequently to steps 620 and 630, respectively.

Additionally a timer 640 may be appropriate between instructions so that the manager may reuse the same windows, instead of multiple windows, as to prevent a pop-up blocker from blocking consecutive new windows.

To change some or all passwords of the application 106, the manager may have a sequence of actions to change the password (either defined by the user or the manager administrator), and may also contains a valid format of password for a given one of the applications. The user may ask the manager 104 to record the actions that lead to the password change page. It is acceptable that the manager 104 executes the change password on the server side, because it is more secure. It is possible to send an instruction to the browser to submit a password change to the application 106.

For instance, the user puts a timer on the action, so that AuthenticationWare.com changes the password for SeattleEmail.com and BankOfSeattle.com on 07/20/04 at 5:00 AM. The AuthenticationWare.com will change passwords for SeattleEmail.com and BankOfSeattle.com to random passwords, check if it is successful and save that password as the new password for SeattleEmail.com and BankOfSeattle.com.

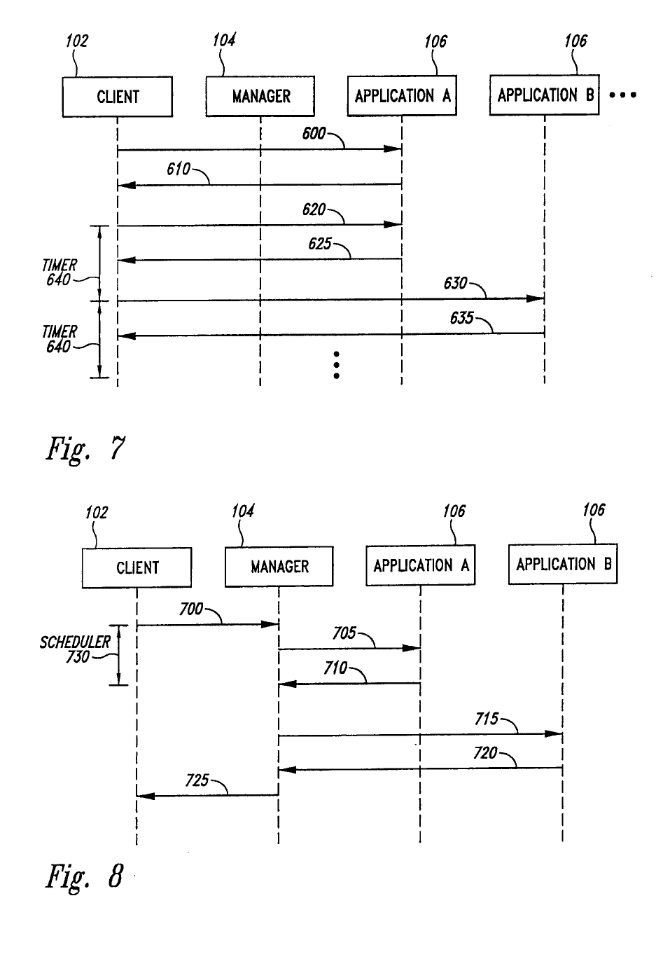

As shown in FIG. 8, the user may initiate the password change by clicking a link, or the manager 104 may execute the action on a user pre-defined time (step 700). The manager 104 populates the change password ASP with appropriate information.

The manager 104 may have a list of the application 106, which already specifies which input fields are for the old password, new password and verify password (step 705). Otherwise, the manager 104 may guess the input fields role, by looking at its position, its name, etc, to populate the ASP inputs.

It is preferred that the manager 104 executes server side authentication to change the authentication code/password the application 106 on behalf of the user. Alternatively, the manager may perform on the client side. The manager 104 will populate the old and new password ASP inputs, as defined by the user. The user may pick a certain password for the application 106 to be assigned as the new password (or from a set of passwords). The user may let the manager 104 picks a random password for the new password. Alternatively, the user may specify a certain password format that the application 106 accepts and the manager 104 generates a password that conforms to the specified format.

The manager 104 parses a response returned by the application 106, to see if it is successful such as a certain text exists (step 710). Alternatively, the manager 104, on behalf of the user, authenticates to the server side with the new password, and verifies if it is successful or not. It is acceptable that the history of old passwords for the application 106 are saved, in case the password change is not successful. Steps 715 and 720 are similar to steps 705 and 710 only for another one of the applications 106. Once all of the applications 106 have had their passwords changed, a response is send back from the manager 104 to the client device 102 (step 725).

Additionally, a scheduler 730 may be appropriate for changing the password(s) on a determined schedule.

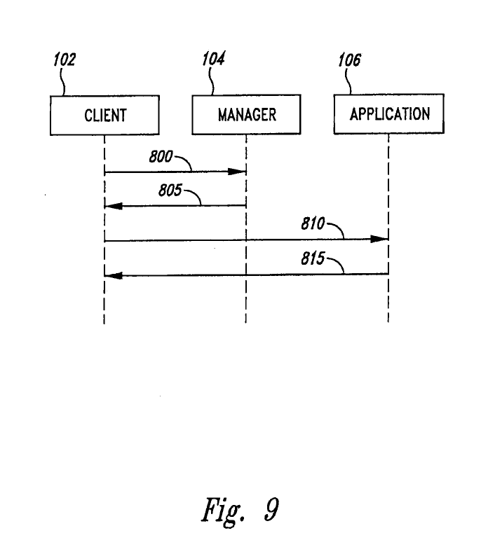

As described in the previous section, to automatically authenticate the user, the user selects the authentication data on the manager 104 (step 800) as shown in FIG. 9. The manager 104 will send a web content, containing an authentication data (step 805). The browser in user's device will execute a script (embedded in the web content) to send the authentication data to the application 106 (step 810). The application 106 receives the authentication data, and sends a web content (customized page for that user—for example: a list of transaction in user's bank account, if the user authenticates to BankOfSeattle.com) to the user (step 815).

Instead of authentication, the user may save any type of ASP input. Using any browser and any computer, the user may ask the manager to input the ASP. This way, the user doesn't have to re-enter all of the information.

For example, the user wants to check an airplane ticket price; see how much it costs on any particular date. Instead of entering the preferred departure & return dates, the departure & the destination airports, and number of travelers, the user may save all of this information to AuthenticationWare.com. So, the user may easily check the ticket price, by clicking on a link, instead of filling out the information every time. The user may set this up from his/her office computer, and check several days later using his/her cell phone or home computer.

Regarding sharing passwords, the authentication data on the manager 104 will be able to be used by other users (recipients) who don't set up the authentication data. The user may share and manage the authentication data, by selecting existing recipients on the manager 104 or sending a unique ID/link, most likely to the recipients' email. The recipient is able to use the web application 106 without knowing the authentication data to the web application 106. The actual value of authentication data will be harder to obtain by the recipients, because the manager 104 implements prevention actions.

For instance, a company owner may have an account on BankOfSeattle.com, and this account is shared by many users (people in the company's accounting department, for example). Instead of sending the value of authentication name and password to those users, the company owner may share the authentication data entry using AuthenticationWare.com. Each user creates his/her own account on AuthenticationWare.com, and the owner adds those existing users as the ones that may use (or automatically authenticate to) the account on BankOfSeattle.com.

The owner may ask the manager 104 to hide the authentication data from the users, so that those users may not view values of the authentication name and password for BankOfSeattle.com. Also, the user may not easily get the value of authentication name and password by looking at the source code. The owner may change the password of BankOfSeattle.com, and those users will still be able to authenticate, without having the owner to update the value of authentication data to the users. The owner may prevent some existing users from using the account, without effecting other users or changing the password for BankOfSeattle.com account, by removing the users' privilege over the authentication data usage in AuthenticationWare.com.

Some of the examples may have been described using terminology specific to HTML, however, this was not intended as a limitation, since implementations may easily be implemented in WAP, or other formats.

Although this is mostly used for managing authentication, this application also may be used to store and re-send any type of information, such as re-submitting a query for an airplane ticket price. This query may be accessed from anywhere, anytime; so that the user doesn't have to enter the airplane time and destination every time from a different device. Also, the user may pre-define an action, such as to place a bid on an auction website, and execute the action anytime using a cell phone.

From the foregoing it will be appreciated that, although specific embodiments of the invention have been described herein for purposes of illustration, various modifications may be made without deviating from the spirit and scope of the invention. Accordingly, the invention is not limited except as by the appended claims.

### Aspects

1. A web-based authentication manager for a client device operated by a user and for a web-based application, the authentication manager, the client device, and the web-based application communicatively linked to each other via a network, the web-based authentication manager comprising:

a client database including first client authentication data associated with the user, the client database including web-based application authentication data to be used at least in part to log the client device operated by the user into the web-based application;

a communication module configured to communicate with the client device via the network to receive second client authentication data associated with the user from the client device, the communication module configured to communicate with the web-based application via the network; and

a control module configured to compare the first client authentication data in the client database with the second client authentication data received by the communication module from the client device to determine whether to grant access to the user through the client device, the control module configured to send the web-based application authentication data to the client device via the network through the communication module if the control module has determined to grant access to the user.

2. The web-based authentication manager of aspect 1 wherein the communication module receives the second client authentication data from the client device by a script resident on the client device redirecting the second client authentication data to the web-based authentication manager.

3. The web-based authentication manager of aspect 1 wherein the web-based application authentication data is updated on an on-going basis from information received by the communication module from the web-based application.

4. The web-based authentication manager of aspect 1 wherein the control module is further configured to detect the browser and operating system of the client device when the second client authentication data is received.

5. The web-base authentication manager of aspect 1 wherein at least a portion of the web-based application authentication data is encrypted.

6. The web-based authentication manager of aspect 1 wherein for a second web-based application not yet having associated web-based application authentication data in the client database, the control module is configured to send a unique identifier to the second web-based application device to receive the associated web-based application authentication data from the web-based application, the unique identifier being initially sent from the second web-based application device to the client device and subsequently received by the communication module from the client.

7. The web-based authentication manager of aspect 1 wherein a portion of the web-based application authentication data is modified by the client device subsequent to initial storage web-base application authentication data.

8. The web-based authentication manager of aspect 1 wherein the control module is further configured to modify a display of the web-based application to send to the client device to request web-based application authentication data for the web-based application from the client device.

9. The web-based authentication manager of aspect 8 wherein the modified display is sent to the client device from a first domain and the control module compares the first client authentication data with the second client authentication data in a second domain apart from the first domain.

10. The web-based authentication manager of aspect 9 wherein the control module is further configured to send on to the web-based application, the web-based application authentication data for the web-based application received from the client device through the modified display.

11. The web-based authentication manager of aspect 10 wherein the display of the web-based application is modified to maintain a consistent appearance related to displays of other web-based applications modified by the control module.

12. The web-based authentication manager of aspect 1 wherein the control module is further configured to send a request to the web-based application via the network through the communication module a update to the web-based application authentication data after receipt by the communication module of the second client authentication data from the client device.

13. The web-based authentication manager of aspect 1 wherein the control module is further configured to transmit through the communication module to the client device a list of web-based applications including the web-based application.

14. The web-based application manager of aspect 13 wherein the control module is further configured to receive from the client device through the communication module a web application choice indicating that the user has selected the web-based application to log into.

15. The web-based authentication manager of aspect 1 wherein the first client authentication data and the second client authentication data include a URL address for the client device.

16. The web-based authentication manager of aspect 1 wherein the web-based application authentication data is all information required to log into the web-based application.

17. The web-based authentication manager of aspect 1 wherein the web-based application authentication data is a script that allows the client device to log into the web-based application using the second client authentication data associated with the user.

18. A method for a first server, for a client device operated by a user, and for a web-based application, the first server, the client device, and the web-based application communicatively linked to each other via a network, the method comprising:

storing on the first server, first client authentication data associated with the user;

storing on the first server, web-based application authentication data to be used at least to log the client device operated by the user into the web-based application;

receiving second client authentication data associated with the user on the first server via the network from the client device

comparing on the first server, the first client authentication data with the second client authentication data to determine whether to grant access to the client device operated by the user; and

if the comparing indicates to grant access to the user, sending the web-based application authentication data from the first server to the client device.

19. The method of aspect 18, further comprising, sending the web-based application authentication data via the network from the client device to the web-based application to log the client device operated by the user into the web-based application.

20. The method of aspect 18, further comprising, redirecting a transmission from the client device originally addressed to the web-based application containing at least a portion of the second client authentication data to the first server by a script operating on the client device.

21. The method of aspect 18, further comprising, updating the web-based application authentication data from information received by the communication module from the web-based application.

22. The method of aspect 18, further comprising, at the first server, detecting the browser and operating system of the client device when the second client authentication data is received at the first server.

23. The method of aspect 18, further comprising, encrypting at least a portion of the web-based application authentication data.

24. The method of aspect 18 for a second web-based application not yet having associated web-based application authentication data stored in the first server, the method further comprising, sending second web-based application authentication data via the network from the client device to the second web-based application to log into the second web-based application from the client device; receiving a unique identifier at the client device from the second web-based application;, sending the unique identifier from the client device to the first server via the network; sending the unique identifier from the first server to the second web-based application via the network; receiving via the network the second web-based application authentication data at the first server from the web-based application,.

25. The method of aspect 18, further comprising, from the client device, subsequently modifying a portion of the web-based application authentication data stored in the first server.

26. The method of aspect 18, further comprising, at the first server modifying a display of the web-based application to send to the client device to request web-based application authentication data for the web-based application from the client device.

27. The method of aspect 26, further comprising, sending the modified display to the client device from a first domain and comparing the first client authentication data with the second client authentication data in a second domain apart from the first domain.

28. The method of aspect 26, further comprising, sending from the first server via the network on to the web-based application, the web-based application authentication data for the web-based application received from the client device through the modified display.

29. The method of aspect 26, further comprising, modifying the display of the web-based application at the first to maintain a consistent appearance related to displays of other web-based applications modified and sent to the client device from the first server.

30. The method of aspect 18, further comprising, from the first server, sending a request to the web-based application via the network to update the web-based application authentication data after receipt by the first server of the second client authentication data from the client device.

31. The method of aspect 18, further comprising, transmitting from the first server to the client device a list of web-based applications including the web-based application.

32. The method of aspect 31, further comprising, at the first server receiving from the client device a web application choice indicating that the user operating the client device has selected the web-based application to log into.

33. The method of aspect 18 wherein the first client authentication data and the second client authentication data include a URL address for the client device.

34. The method of aspect 18 wherein the web-based application authentication data is all information required to log into the web-based application.

35. The method of aspect 18 wherein the web-based application authentication data is a script that allows the client device to log into the web-based application using the second client authentication data associated with the user.

36. A computer-readable medium having computer-executable instructions that when executed perform a method, the method for a first server, for a client device operated by a user, and for a web-based application, the first server, the client device, and the web-based application communicatively linked to each other via a network, the method comprising:

storing on the first server, first client authentication data associated with the user;

storing on the first server, web-based application authentication data to be used at least to log the client device operated by the user into the web-based application;

receiving second client authentication data associated with the user on the first server via the network from the client device

comparing on the first server, the first client authentication data with the second client authentication data to determine whether to grant access to the client device operated by the user; and

if the comparing indicates to grant access to the user, sending the web-based application authentication data from the first server to the client device.

37. The computer-readable medium of aspect 36 wherein the method further comprises sending the web-based application authentication data via the network from the client device to the web-based application to log the client device operated by the user into the web-based application.

38. The computer-readable medium of aspect 36 wherein the method further comprises redirecting a transmission from the client device originally addressed to the web-based application containing at least a portion of the second client authentication data to the first server by a script operating on the client device.

39. The computer-readable medium of aspect 36 wherein the method further comprises updating the web-based application authentication data from information received by the communication module from the web-based application.

40. The computer-readable medium of aspect 36 wherein the method further comprises at the first server, detecting the browser and operating system of the client device when the second client authentication data is received at the first server.

41. The computer-readable medium of aspect 36 wherein the method further comprises encrypting at least a portion of the web-based application authentication data.

42. The computer-readable medium of aspect 36 wherein the method further comprises for a second web-based application not yet having associated web-based application authentication data stored in the first server, the method further comprising, sending second web-based application authentication data via the network from the client device to the second web-based application to log into the second web-based application from the client device; receiving a unique identifier at the client device from the second web-based application;, sending the unique identifier from the client device to the first server via the network; sending the unique identifier from the first server to the second web-based application via the network; receiving via the network the second web-based application authentication data at the first server from the web-based application.

43. The computer-readable medium of aspect 36 wherein the method further comprises from the client device, subsequently modifying a portion of the web-based application authentication data stored in the first server.

44. The computer-readable medium of aspect 36 wherein the method further comprises at the first server modifying a display of the web-based application to send to the client device to request web-based application authentication data for the web-based application from the client device.

45. The computer-readable medium of aspect 44 wherein the method further comprises sending the modified display to the client device from a first domain and comparing the first client authentication data with the second client authentication data in a second domain apart from the first domain.

46. The computer-readable medium of aspect 44 wherein the method further comprises sending from the first server via the network on to the web-based application, the web-based application authentication data for the web-based application received from the client device through the modified display.

47. The computer-readable medium of aspect 44 wherein the method further comprises modifying the display of the web-based application at the first to maintain a consistent appearance related to displays of other web-based applications modified and sent to the client device from the first server.

48. The computer-readable medium of aspect 36 wherein the method further comprises from the first server, sending a request to the web-based application via the network to update the web-based application authentication data after receipt by the first server of the second client authentication data from the client device.

49. The computer-readable medium of aspect 36 wherein the method further comprises transmitting from the first server to the client device a list of web-based applications including the web-based application.

50. The computer-readable medium of aspect 49 wherein the method further comprises at the first server receiving from the client device a web application choice indicating that the user operating the client device has selected the web-based application to log into.

51. The computer-readable medium of aspect 36 wherein the first client authentication data and the second client authentication data include a URL address for the client device.

52. The computer-readable medium of aspect 36 wherein the web-based application authentication data is all information required to log into the web-based application.

53. The computer-readable medium of aspect 36 wherein the web-based application authentication data is a script that allows the client device to log into the web-based application using the second client authentication data associated with the user.

What is claimed is:

1. A web-based authentication manager for a client device operated by a user and for a web-based application, the authentication manager, the client device, and the web-based application communicatively linked to each other via a network, the web-based authentication manager comprising:
a client database including web-based application authentication data to be used at least in part to log the client device operated by the user into the web-based application;
a communication module configured to communicate with the client device via the network to receive a web-based application choice from the client device and send web-based application authentication data to the client device, the communication module configured to communicate with the web-based application via the network; and
a control module configured to send the web-based application authentication data through the communication module to the client device via the network whereby the client device is enabled to send the web-based application authentication data to the web-based application.

2. The web-based authentication manager of claim 1 wherein the client database further includes a first client authentication data associated with the user and wherein the control module is configured to grant access to the user by comparing the first client authentication data with a second client authentication data received by the control module from the client device.

3. The web-based authentication manager of claim 1 wherein the control module is configured to send the web-based application data as plain text to the client device.

4. The web-based authentication manager of claim 1 wherein the control module is further configured to detect the browser and operating system of the client device when the web-based application choice is received.

5. The web-based authentication manager of claim 1 wherein at least a portion of the web-based application authentication data that is sent to client device is encrypted.

6. The web-based authentication manager of claim 1 wherein for a second web-based application not yet having associated web-based application authentication data in the client database, the control module is configured to send a unique identifier to the second web-based application device to receive the associated web-based application authentication data from the web-based application, the unique identifier being initially sent from the second web-based application device to the client device and subsequently received by the communication module from the client.

7. The web-based authentication manager of claim 1 wherein a portion of the web-based application authentication data is modified by the client device subsequent to initial storage web-based application authentication data.

8. The web-based authentication manager of claim 1 wherein the control module is further configured to modify a display of the web-based application to send to the client device to request web-based application authentication data for the web-based application from the client device.

9. The web-based authentication manager of claim 1 wherein the communication module is configured to send a modified version of a display of the web-based application to the client device.

10. The web-based authentication manager of claim 9 wherein the communication module is further configured to receive the web-based application authentication data from the client device through the modified version of the display.

11. The web-based authentication manager of claim 10 wherein the control module is further configured to send on to the web-based application, the web-based application authentication data for the web-based application received from the client device through the modified version of the display for verification of the web-based application authentication data.

12. The web-based authentication manager of claim 9 wherein the modified version of the display of the web-based application is modified to maintain a consistent appearance related to displays of the web-based applications modified by the control module.

13. The web-based authentication manager of claim 1 wherein the client device is configured to send a web-based application choice to the communication module.

14. The web-based application manager of claim 13 wherein the communication module is further configured to receive search requests from the client device preceding receipt of the web-based application choice.

15. The web-based authentication manager of claim 14 is further configured to send a web-based application choice prompt to the client device to prompt the web-based application choice from the client device.

16. The web-based authentication manager of claim 15 wherein the communication module is further configured to send the web-based application choice prompt to the client device on a first domain to prompt a receipt of the web-based application choice from the client device and the communication module is further configured to send the web-based application authentication data to the client device on a second domain.

17. The web-based authentication manager for the web-based application having an authentication page of claim 1 wherein the control module is further configured to send a request for the authentication page containing parameter data from the web-based application via the network through the communication module to update the web-based application authentication data.

18. The web-based authentication manager of claim 1 wherein the control module is further configured to transmit through the communication module to the client device a list of web-based applications and is further configured to receive from the client device through the communication module a web application choice indicating that the user has selected the web-based application to log into.

19. The web-based authentication manager of claim 1 wherein the web-based authentication data includes a URL address for the client device.

20. The web-based authentication manager of claim 1 wherein the web-based application authentication data includes a script that allows the client device to log into the web-based application.
